(19) United States
(12) Patent Application Publication
(10) Pub. No.: US 2007/0182696 A1
(43) Pub. Date: Aug. 9, 2007

(54) Liquid crystal display device and controlling method thereof

(75) Inventor: Feng-Li Lin, Taishan Township (TW)

Correspondence Address: BIRCH STEWART KOLASCH & BIRCH, PO BOX 747, FALLS CHURCH, VA, 22040-0747, US

(73) Assignee: GIGNO TECHNOLOGY CO., LTD.

(21) Appl. No.: 11/471,643

(22) Filed: Jun. 21, 2006

(30) Foreign Application Priority Data
Feb. 9, 2006 (TW) 095104443

(51) Int. Cl. G09G 3/36

(52) U.S. Cl. 345/102

(57) ABSTRACT

A control method is for inputting a plurality of image frame data into a liquid crystal display device in order. The liquid crystal display device includes a plurality of light-emitting units as the backlighting and a display screen, and has a preset display mode reference. The display screen is divided into a plurality of display areas, and each image frame data has a plurality of area image frame data corresponding to each display area. The method includes an area image frame data comparison/judgment procedure and an area light-emitting unit control procedure. The area image frame data comparison/judgment procedure, which is applied to one display area, is to compare at least two area image frame data displayed in the display area at different timings so as to generate an area image display parameter, and then to determine whether the display area should perform an area synchronization flash control mode or not according to the area image display parameter and the display mode reference. If the area image frame data comparison/judgment procedure determines that the display area should perform the area synchronization flash control mode, the area light-emitting unit control procedure is to control the light-emitting unit corresponding to the display area to perform the area synchronization flash control mode.

### BACKGROUND OF THE INVENTION

1. Field of Invention

The invention relates to a liquid crystal display device and a control method thereof, and, in particular, to a liquid crystal display device and a control method thereof, which can perform a flash control of the display area(s) displaying the animation.

2. Related Art

Recently, the liquid crystal display devices are widely used in many application fields. For example, the liquid crystal display device can be used as a monitor of a computer, a touch control panel for the human-machine interface (HMI), or a television for cooperating with the video system. Although it can be used in many application fields, there are some technical problems to be solved, such as the view angle problem, the contrast problem, the color saturation problem, and the response time problem.

Accompanying the development of the technology, most of the above-mentioned problems are well treated, but it still needs more efforts to solve the response time problem. The goal for solving the response time problem is to make the liquid crystal display device having the animation display effect as a CRT (cathode-ray tube) displayer. The reason why the conventional liquid crystal display device can not achieve the desired animation display effect is that, excepting the limitation of response time, the conventional liquid crystal display device renders the hold-type display method, which is different from the impulse-type display method used in the CRT displayer.

As mentioned above, regarding to the impulse-type display method, the human eyes may not have the blurring phenomenon when tracking the motion object on the screen. Alternatively, regarding to the hold-type display method, the human eyes may have the blurring phenomenon when tracking the motion object on the screen.

Recently, the manufacturer discloses a blinking technology for solving the blurring phenomenon. The blinking technology is to repeatedly turn on and turn off the light-emitting units of the backlighting, so that the backlighting of the liquid crystal display device can imitate the impulse-type display method so as to eliminate the blurring phenomenon. However, since the light-emitting units are turned on/off repeatedly, the luminance of the display screen may change by a wide margin, which leads to the flicker phenomenon in vision.

In addition, the manufacturer also discloses a sequential flashing technology for solving the blurring phenomenon. The sequential flashing technology is to light on and turn off the light-emitting units during a frame time in sequence, so that the light-emitting units can flash in turn to imitate the impulse-type display method for improving the blurring phenomenon of the motion image. However, when the screen displays the motionless image, and the light-emitting units still flash, the motionless image may have the flicker phenomenon in vision. In addition, when the screen displays the motion image in part with the residual part of the motionless image, and the light-emitting units still flash, the residual part of the motionless image may have flicker phenomenon in vision.

Therefore, it is an important subject of the invention to provide a liquid crystal display device and a control method thereof for improving the blurring phenomenon and preventing the flicker phenomenon.

### SUMMARY OF THE INVENTION

In view of the foregoing, the invention is to provide a liquid crystal display device and a control method thereof, which can improve the blurring phenomenon and prevent the flicker phenomenon.

To achieve the above, a control method of the invention is used for inputting a plurality of image frame data into a liquid crystal display device in order. The liquid crystal display device includes a plurality of light-emitting units as a backlighting and a display screen, and has a preset display mode reference. The display screen is divided into a plurality of display areas, each of which corresponds to one of the light-emitting units. Each of the image frame data includes a plurality of area image frame data corresponding to the display areas, respectively. The method includes an area image frame data comparison/judgment procedure and an area light-emitting unit control procedure. The area image frame data comparison/judgment procedure compares at least two of the area image frame data displayed in one of the display areas at different timings so as to generate an area image display parameter, and then determines whether the display area should perform an area synchronization flash control mode or not according to the area image display parameter and the display mode reference. If the area image frame data comparison/judgment procedure determines that the display area should perform the area synchronization flash control mode, the area light-emitting unit control procedure controls the light-emitting unit corresponding to the display area to perform the area synchronization flash control mode.

In addition, to achieve the above, a liquid crystal display device of the invention includes a plurality of light-emitting units as a backlighting and a display screen, and has a preset display mode reference. The display screen is divided into a plurality of display areas, each of which corresponds to one of the light-emitting units. Each of the image frame data includes a plurality of area image frame data respectively corresponding to the display areas. In the invention, the liquid crystal display device includes an area image frame data comparison/judgment module and an area light-emitting unit control module. The area image frame data comparison/judgment module compares at least two of the area image frame data displayed in one of the display areas at different timings so as to generate an area image display parameter, and then generates an area luminance control signal according to the area image display parameter and the display mode reference. The area light-emitting unit control module, which is electrically connected with the area image frame data comparison/judgment module, controls at least the light-emitting unit corresponding to the display area to perform a luminance control mode according to the area luminance control signal.

As mentioned above, the liquid crystal display device and the control method thereof of the invention are to obtain an area image display parameter by comparing/calculating the pixel data of the area image frame data, and to determine whether the area image frame data represents an animation display mode or not after comparing the area image display parameter and the display mode reference. Then, the invention can decide whether to perform an area synchronization flash control mode on the display area. Accordingly, the invention can improve the blurring phenomenon and prevent the flicker phenomenon of the liquid crystal display device.

### BRIEF DESCRIPTION OF THE DRAWINGS

The invention will become more fully understood from the detailed description given herein below illustration only, and thus is not limitative of the present invention, and wherein:

FIG. 1 is a schematic diagram showing image frame data, which are inputted into a liquid crystal display device according to a preferred embodiment of the invention;

FIG. 2 is a schematic diagram showing image frame data, which are inputted into another liquid crystal display device according to the embodiment of the invention;

FIG. 3 is a flow chart showing the procedures of a control method of a liquid crystal display device according to a preferred embodiment of the invention;

FIG. 4 is a flow chart showing the steps of the control method of a liquid crystal display device according to the embodiment of the invention;

FIG. 5 is a flow chart showing the steps of another control method of a liquid crystal display device according to the embodiment of the invention;

FIG. 6 is a schematic diagram showing a liquid crystal display device according to a preferred embodiment of the invention;

FIG. 7 is a timing chart showing the control of the light-emitting units of the liquid crystal display device according to the embodiment of the invention, wherein L₂ and L₃ represent the timings for continuously lighting up the light-emitting units, and T_{F} represents an image frame data time;

FIG. 8 is a timing chart showing the another control of the light-emitting units of the liquid crystal display device according to the embodiment of the invention, wherein L₃ represents the timing for continuously lighting up the light-emitting unit, and T_{F} represents an image frame data time;

FIG. 9 is a timing chart showing yet another control of the light-emitting units of the liquid crystal display device according to the embodiment of the invention, wherein L₂ and L₃ represent the timings for performing the flash control mode having a frequency different from the writing frequency of the image frame data, and T_{F} represents an image frame data time; and

FIG. 10 is a timing chart showing still another control of the light-emitting units of the liquid crystal display device according to the embodiment of the invention, wherein L₃ represents the timing for performing the flash control mode having a frequency different from the writing frequency of the image frame data, and T_{F} represents an image frame data time.

### DETAILED DESCRIPTION OF THE INVENTION

The present invention will be apparent from the following detailed description, which proceeds with reference to the accompanying drawings, wherein the same references relate to the same elements.

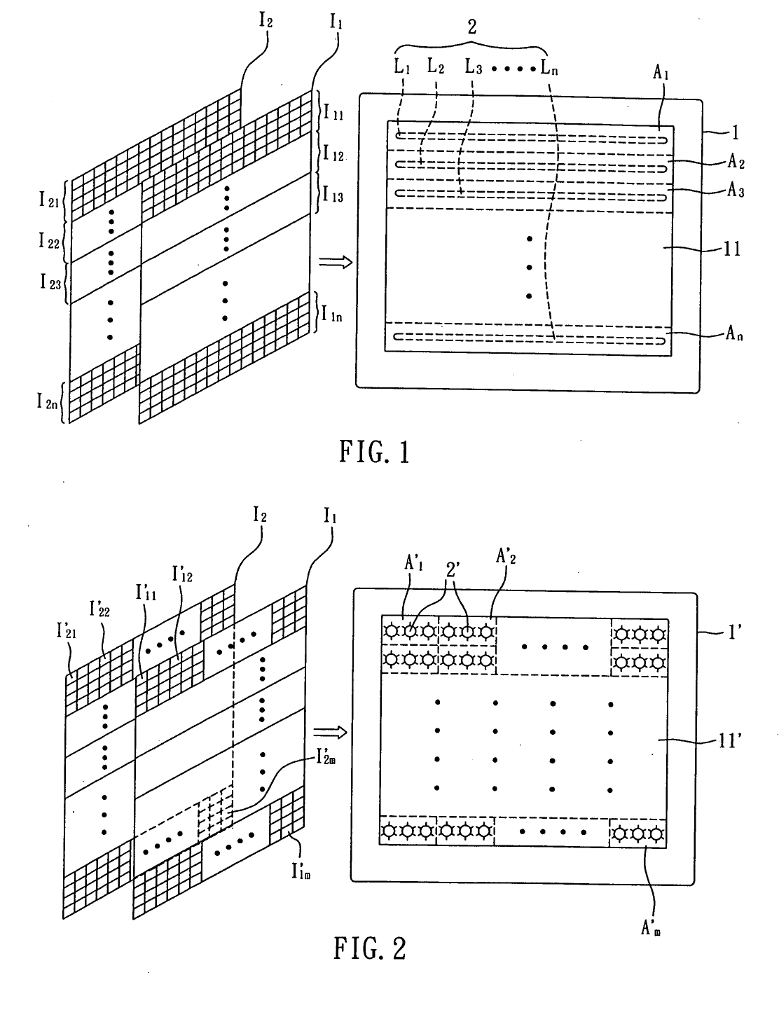

It should be known that the common display method is to continuously display a plurality of image frame data, which are inputted to a liquid crystal display device in sequence, to show the moving image. As shown in FIG. 1, a liquid crystal display device 1 usually includes a display screen 11 and light-emitting units 2, such as the cold cathode fluorescent lamps (CCFL), as the backlighting. Of course, the light-emitting units may be other light sources. As shown in FIG. 2, another liquid crystal display device 1′ includes a display screen 11′ and light-emitting units 2′, such as the light-emitting diodes (LED), as the backlighting.

Hereinafter, the light-emitting units are, for example, the cold cathode fluorescent lamps for describing a control method of a liquid crystal display device according to a preferred embodiment of the invention.

With reference to FIG. 1, the liquid crystal display device 1 has a preset display mode reference. In the embodiment, the display mode reference is an animation display mode reference for determining whether a display screen 11 displays the animation image. As shown in FIG. 1, the display screen 11 is divided into a plurality of display areas A₁ to Aₙ, wherein n is positive integer. Each of the display areas A₁ to Aₙ corresponds to one of the light-emitting units 2 (L₁ to Lₙ, wherein n is positive integer). Each of the image frame data includes a plurality of area image frame data respectively corresponding to the display areas A₁ to Aₙ. In this embodiment, each light-emitting unit 2 includes one cold cathode fluorescent lamp only, but it may include several cold cathode fluorescent lamps in practice.

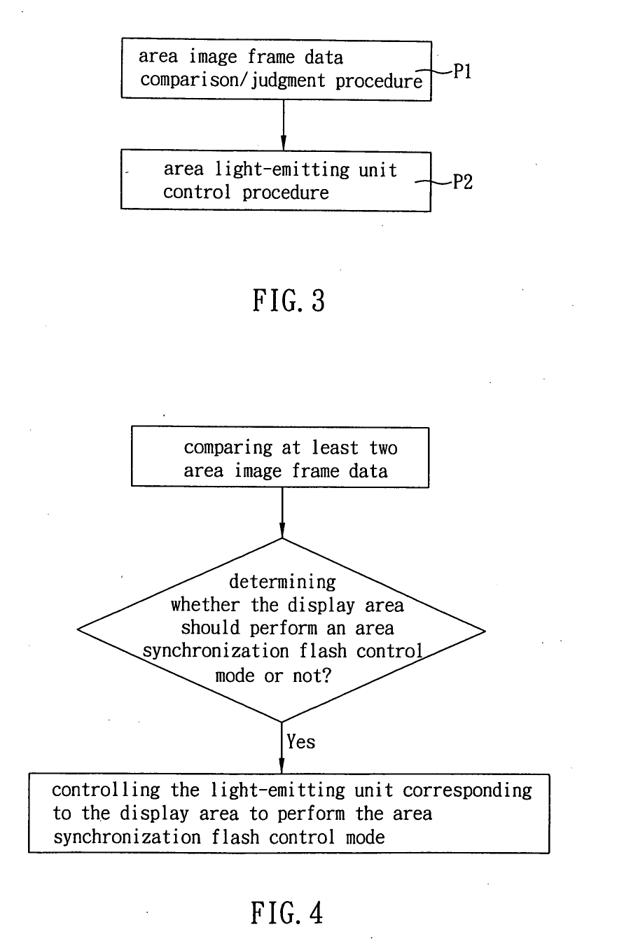

With reference to FIG. 3, the control method of the liquid crystal display device according to the embodiment of the invention includes an area image frame data comparison/judgment procedure P1 and an area light-emitting unit control procedure P2.

The area image frame data comparison/judgment procedure P1 is applied to any one of the display areas A₁ to Aₙ. Taking the display area A₁ as an example, the area image frame data comparison/judgment procedure P1 is for comparing at least two area image frame data I₁₁ and I₂₁, which are displayed in the display area A₁ at different timings, so as to generate an area image display parameter. Then, the procedure P1 determines whether the display area A₁ should perform an area synchronization flash control mode or not according to the area image display parameter and the display mode reference. In particular, the two area image frame data I₁₁ and I₂₁ may respectively belong to two sequentially inputted image frame data or two non-sequentially inputted image frame data. In other words, the first image flame data I₁ and the second image frame data I₂ may be sequentially inputted image frame data or non-sequentially inputted image frame data.

With reference to FIG. 1 in view of FIG. 4, the first image frame data I₁ and the second image frame data I₂ respectively include a plurality of area image frame data I₁₁ to I₁ₙ and area image flame data I₂₁ to I₂ₙ, wherein n is positive integer. Each of the area image frame data I₁₁ to I₁ₙ and I₂₁ to I₂ₙ contains a plurality of pixel data for displaying its corresponding display area. Each of the pixel data is composed of sub-pixel values, such as the RGB sub-pixel values or YUV sub-pixel values, and includes 24 bits. Each color sub-pixel value (Red, Green, or Blue) is represented by 8 bits, which means 0 to 255. In the embodiment, the procedure P1 can calculate the area image display reference, which represents the motion composition, according to each color sub-pixel value of each area image flame data I₁₁ to I₁ₙ and each color sub-pixel value of each corresponding area image frame data I₂₁ to I₂ₙ. Then, the procedure P1 determines whether the display area should perform an area synchronization flash control mode or not according to each area image display parameter and the display mode reference. In the present embodiment, when the area image display parameter is larger than the display mode reference, the procedure P1 determines that the display area should perform the area synchronization flash control mode. In this case, the display mode of the display area is an animation display mode. To be noted, the calculating method for obtaining the above-mentioned result is not limited to the previously described method. For example, the optical flow technique may also be used to calculate the motion composition of the display screen.

The area light-emitting unit control procedure P2 controls the light-emitting unit corresponding to the display area to perform the area synchronization flash control mode if the area image frame data comparison/judgment procedure P1 determines that the display area should perform the area synchronization flash control mode. Herein, the area synchronization flash control mode is to control the luminance intensities of the light-emitting unit corresponding to the display area to present a periodical luminance waveform. The luminance waveform and a timing of the area image frame data written into the display area are synchronized with a phase difference. In this embodiment, the phase difference is ranged from 0 to 360 degrees.

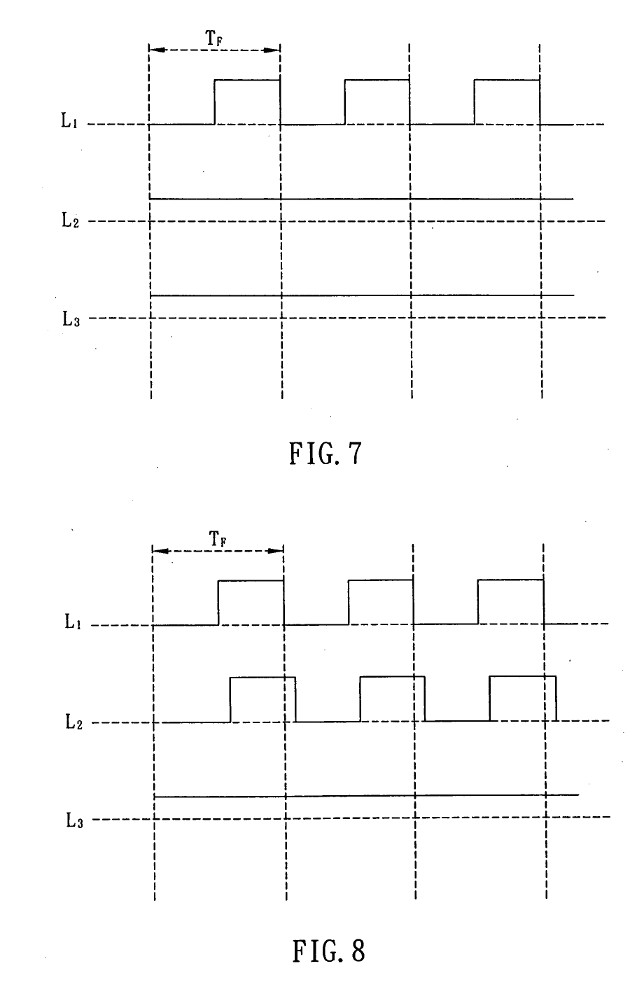

FIG. 7 is a timing chart showing the driven light-emitting units. As shown in FIG. 7, when the display area Al is determined as an animation display mode, it performs an area synchronization flash control mode for executing an area flash control on the light-emitting unit L₁ corresponding to the display area A₁. Accordingly, the backlighting of the display area presents a periodical luminance waveform. In addition, as shown in FIG. 8, the area light-emitting unit control procedure P2 performs the area synchronization flash control mode by controlling luminance intensities of the light-emitting unit L₁ corresponding to the display area A₁ and another light-emitting unit L₂ corresponding to another display area A₂ adjacent to the display area A₁ to present a periodical luminance waveform. The periodical luminance waveform and a timing of the area image frame data written into the display areas are synchronized with a phase difference.

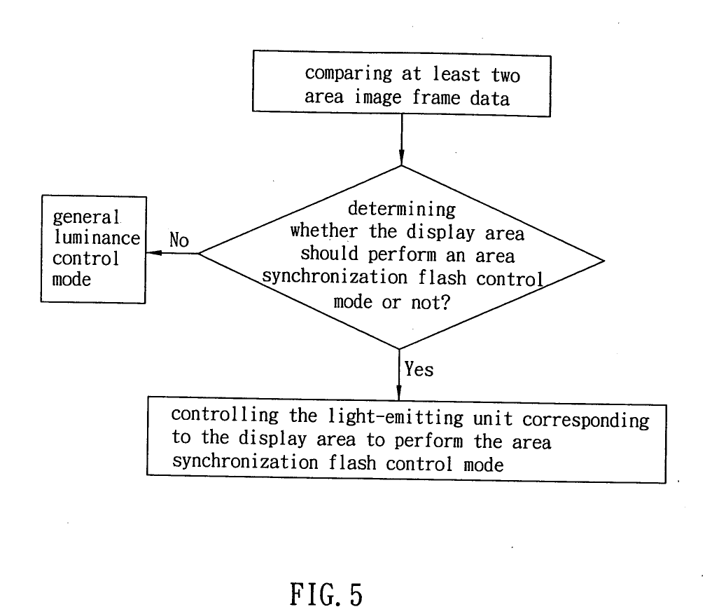

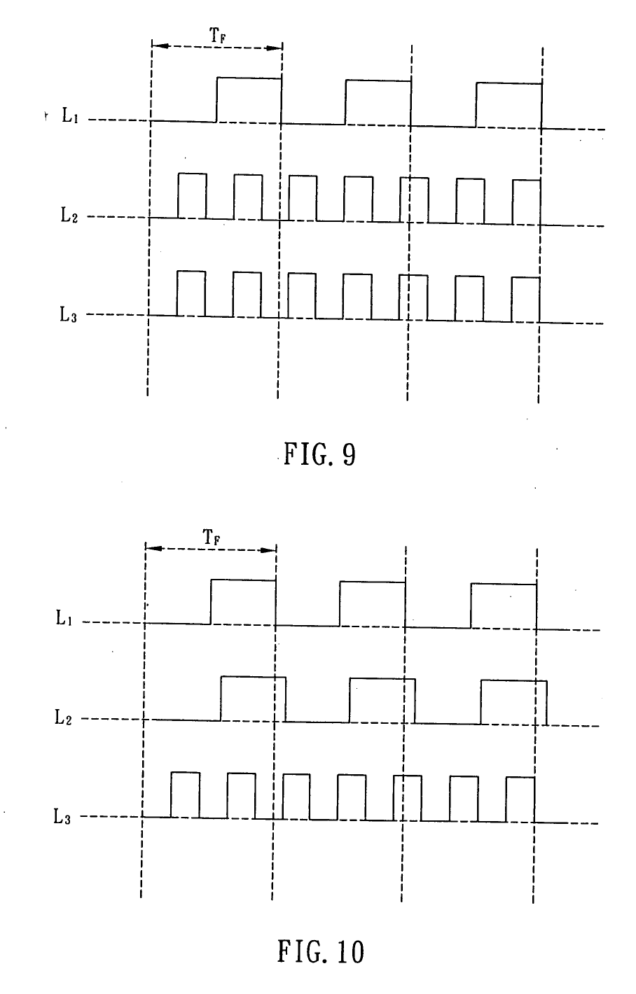

With reference to FIG. 5, when the area image frame data comparison/judgment procedure P1 determines that the display area should not perform the area synchronization flash control mode, the area light-emitting unit control procedure P2 controls the light-emitting unit corresponding to the display area to perform a general luminance control mode. Herein, the general luminance control mode is to continuously light on the light-emitting unit or to control the light-emitting unit with a flash control mode having a frequency different from the writing frequency of the image frame data. The reference numbers L₂ and L₃ of FIG. 7 and L₃ of FIG. 8 represent the timing of the continuously lighted light-emitting unit. The reference numbers L₂ and L₃ of FIG. 9 and L₃ of FIG. 10 represent the timing of the light-emitting unit, which is controlled with the flash control mode having a frequency different from the writing frequency of the image frame data.

With reference to FIG. 2, the light-emitting units are the light-emitting diodes.

With reference to FIG. 2, the liquid crystal display device 1′ has a preset display mode reference. In the embodiment, the display mode reference is an animation display mode reference for determining whether a display screen 11 displays the animation image. As shown in FIG. 2, the display screen 11′ is divided into a plurality of display areas A′₁ to A′ₘ, wherein m is positive integer. Each of the display areas A′₁ to A′ₘ corresponds to one of the light-emitting units 2′. Each of the image frame data includes a plurality of area image frame data respectively corresponding to the display areas A′₁ to A′ₘ. In this embodiment, each light-emitting unit 2′ may include one light-emitting diode only, or several light-emitting diodes.

The area image frame data comparison/judgment procedure P1 is applied to any one of the display areas A′₁ to A′ₘ. Taking the display area A′₁ as an example, the area image frame data comparison/judgment procedure P1 is for comparing at least two area image frame data I′₁₁ and I′₂₁, which are displayed in the display area A′₁ at different timings, so as to generate an area image display parameter. Then, the procedure P1 determines whether the display area A′₁ should perform an area synchronization flash control mode or not according to the area image display parameter and the display mode reference. In particular, the two area image frame data I′₁₁ and I′₂₁ may respectively belong to two sequentially inputted image frame data or two non-sequentially inputted image frame data. In other words, the first image frame data I₁ and the second image frame data I₂ may be sequentially inputted image frame data or non-sequentially inputted image frame data.

With reference to FIG. 2 in view of FIG. 4, the first image frame data I₁ and the second image frame data I₂ respectively include a plurality of area image frame data I′₁₁ to I′^{1m} and area image frame data I′₂₁ to I₂ₘ, wherein m is positive integer. Each of the area image frame data I′₁₁ to I′₁ₘ and I_{′21} to I′₂ₘ contains a plurality of pixel data for displaying its corresponding display area.

In the embodiment, the procedure P1 can calculate the area image display reference, which represents the motion composition, according to each color sub-pixel value of each area image frame data I′₁₁ to I_{′1m} and each color sub-pixel value of each corresponding area image frame data I′₂₁ to I′₂ₘ. Then, the procedure P1 determines whether the display area should perform an area synchronization flash control mode or not according to each area image display parameter and the display mode reference. The area synchronization flash control mode is the same as that described herein above, so the detailed descriptions are omitted for concise purpose.

As mentioned above, since not all animation display modes lead to the blurring phenomenon, the invention allows the user to manually adjust the preset display mode reference, or allows the liquid crystal display device to automatically adjust the preset display mode reference. Thus, in the invention, the display mode reference can be set to decide what kind of the animation display mode should be perform the area synchronization flash control mode for eliminating the blurring phenomenon.

Since the flicker phenomenon changes according to the luminance, which makes the user having different feelings, the display mode reference of the invention can be modulated depending on a luminance. In the embodiment, the luminance can be a luminance of the liquid crystal display device or an environmental luminance. In general, when the luminance of the liquid crystal display device is bright or the environmental luminance is dark, the user becomes sensitive about the flicker phenomenon. Thus, these conditions are unsuitable for performing the area synchronization flash control mode. As a result, the display mode reference should be modulated higher when the luminance of the liquid crystal display device is brighter, and the display mode reference should be modulated lower when the environmental luminance is brighter.

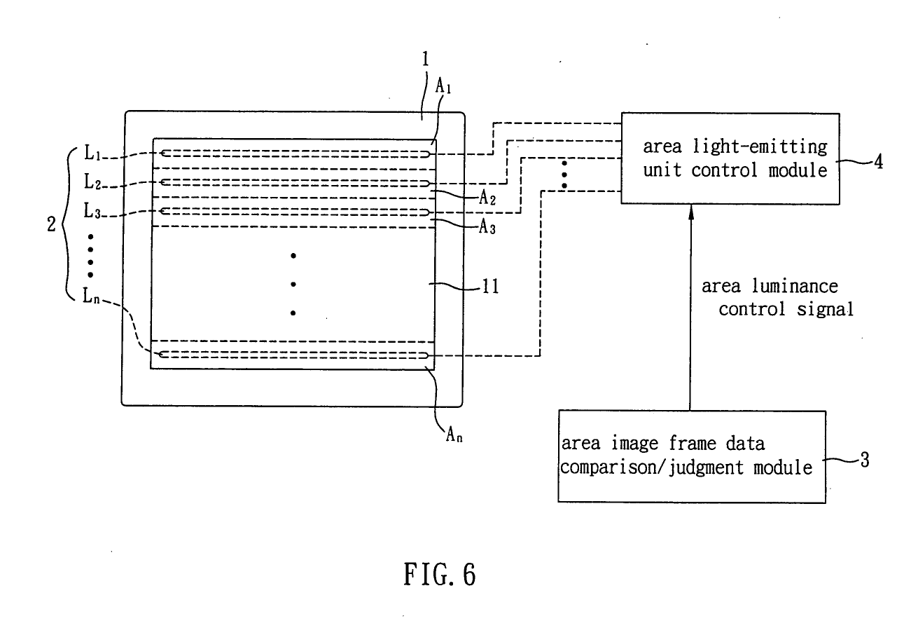

The liquid crystal display device according to a preferred embodiment of the invention will be described hereinafter with reference to FIGS. 6 to 8. To be noted, since the control method of the light-emitting units of the liquid crystal display device is the same as that described herein above, the detailed descriptions are omitted for concise purpose.

With reference to FIG. 6, a liquid crystal display device according to a preferred embodiment of the invention includes an area image frame data comparison/judgment module 3 and an area light-emitting unit control module 4.

As shown in FIG. 6, the liquid crystal display device 1 has a display screen 11 for displaying a plurality of image frame data in order and a preset display mode reference. The display screen 11 is divided into a plurality of display areas A₁ to Aₙ, wherein n is positive integer. Each of the display areas A₁ to Aₙ corresponds to one of the light-emitting units 2. Each of the image frame data includes a plurality of area image frame data respectively corresponding to the display areas A₁ to Aₙ.

The area image frame data comparison/judgment module 3 is applied to any one of the display areas A₁ to Aₙ. The area image frame data comparison/judgment module 3 compares at least two of the area image frame data displayed in one of the display areas at different timings so as to generate an area image display parameter, and then generating an area luminance control signal according to the area image display parameter and the display mode reference.

The area light-emitting unit control module 4, which is electrically connected with the area image frame data comparison/judgment module 3, controls at least the light-emitting unit corresponding to the display area to perform a luminance control mode according to the area luminance control signal.

In the present embodiment, the display mode reference is an animation display mode reference. When the area image display parameter is larger than the display mode reference, the area image frame data comparison/judgment module 3 determines that the display mode of the display area is an animation display mode. In this case, the luminance control mode is an area synchronization flash control mode, which controls the luminance intensity of the light-emitting unit corresponding to the display area to present a periodical luminance waveform (as shown in FIG. 7). The periodical luminance waveform and a timing of the area image frame data written into the display area are synchronized with a phase difference. In addition, the luminance control mode may control the luminance intensities of the light-emitting unit corresponding to the display area and another light-emitting unit corresponding to another display area adjacent to the display area to present a periodical luminance waveform (as shown in FIG. 8). The periodical luminance waveform and a timing of the area image frame data written into the display areas are synchronized with a phase difference.

To be noted, the above descriptions of the embodiment illustrate the case of using the cold cathode fluorescent lamps as the light-emitting units. Alternatively, when using the light-emitting diodes as the light-emitting units, the control method is the same as that described herein above. In addition, since not all animation display modes lead to the blurring phenomenon, the invention allows the user to manually adjust the preset display mode reference, or allows the liquid crystal display device to automatically adjust the preset display mode reference. Thus, in the invention, the display mode reference can be set to decide what kind of the animation display mode should be perform the area synchronization flash control mode for eliminating the blurring phenomenon.

Furthermore, since the flicker phenomenon changes according to the luminance, which makes the user having different feelings, the display mode reference of the invention can be modulated depending on a luminance. In the embodiment, the luminance can be a luminance of the liquid crystal display device or an environmental luminance. In general, when the luminance of the liquid crystal display device is bright or the environmental luminance is dark, the user becomes sensitive about the flicker phenomenon. Thus, these conditions are unsuitable for performing the area synchronization flash control mode. As a result, the display mode reference should be modulated higher when the luminance of the liquid crystal display device is brighter, and the display mode reference should be modulated lower when the environmental luminance is brighter.

In summary, the liquid crystal display device and the control method thereof of the invention break the conventional thought of always performing the flash control or never performing the flash control in one display device. The liquid crystal display device and the control method thereof of the invention are to compare the pixel data of the area image frame data so as to determine whether the area image frame data represents an animation display mode or not and thus decide whether to perform an area synchronization flash control mode on the display area. Regarding to the same display screen, the display areas displaying the motionless image will not perform the area synchronization flash control mode, so that the flicker phenomenon can be prevented. In addition, the display areas displaying the motion image will perform the area synchronization flash control mode, so that the blurring phenomenon can be improved. Moreover, the invention further considers the luminance factor, so that the invention can efficiently improve the blurring phenomenon and prevent the flicker phenomenon of the liquid crystal display device.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A control method for inputting a plurality of image frame data into a liquid crystal display device in order, wherein the liquid crystal display device comprises a plurality of light-emitting units as a backlighting and a display screen, and has a preset display mode reference, the display screen is divided into a plurality of display areas, each of the display areas corresponds to one of the light-emitting units, and each of the image frame data includes a plurality of area image frame data respectively corresponding to the display areas, the method comprising:
an area image frame data comparison/judgment procedure for comparing at least two of the area image frame data displayed in one of the display areas at different timings so as to generate an area image display parameter, and then determining whether the display area should perform an area synchronization flash control mode or not according to the area image display parameter and the display mode reference; and
an area light-emitting unit control procedure for controlling the light-emitting unit corresponding to the display area to perform the area synchronization flash control mode if the area image frame data comparison/judgment procedure determines that the display area should perform the area synchronization flash control mode.

2. The method of claim 1, wherein when the display mode reference is an animation display mode reference and the area image display parameter is larger than the display mode reference, the area image frame data comparison/judgment procedure determines that the display area should perform the area synchronization flash control mode, and the display mode of the display area is an animation display mode.

3. The method of claim 1, wherein the area light-emitting unit control procedure performs the area synchronization flash control mode by controlling a luminance intensity of the light-emitting unit corresponding to the display area to present a periodical luminance waveform, and the periodical luminance waveform and a timing of the area image frame data written into the display area are synchronized with a phase difference.

4. The method of claim 3, wherein the phase difference is ranged from 0 to 360 degrees.

5. The method of claim 1, wherein the area light-emitting unit control procedure performs the area synchronization flash control mode by controlling luminance intensities of the light-emitting unit corresponding to the display area and another one of the light-emitting units corresponding to another one of the display areas adjacent to the display area to present a periodical luminance waveform, and the periodical luminance waveform and a timing of the area image frame data written into the display areas are synchronized with a phase difference.

6. The method of claim 5, wherein the phase difference is ranged from 0 to 360 degrees.

7. The method of claim 1, wherein the area light-emitting unit control procedure controls the light-emitting unit corresponding to the display area to perform a general luminance control mode if the area image frame data comparison/judgment procedure determines that the display area should not perform the area synchronization flash control mode.

8. The method of claim 1, wherein the two of the area image frame data are two sequentially inputted image frame data.

9. The method of claim 1, wherein the two of the area image frame data are two non-sequentially inputted image frame data.

10. The method of claim 1, wherein the display mode reference is modulated depending on a luminance.

11. The method of claim 10, wherein the luminance is a luminance of the liquid crystal display device, and the display mode reference increases as the luminance of the liquid crystal display device increases.

12. The method of claim 10, wherein the luminance is an environmental luminance, and the display mode reference increases as the environmental luminance decreases.

13. The method of claim 1, wherein the display mode reference is automatically adjusted by the liquid crystal display device or manually adjusted by a user.

14. A liquid crystal display device including a plurality of light-emitting units as a backlighting and a display screen, and having a preset display mode reference, wherein the display screen is divided into a plurality of display areas, each of the display areas corresponds to one of the light-emitting units, and each of the image frame data includes a plurality of area image frame data respectively corresponding to the display areas, the device comprising:
an area image frame data comparison/judgment module for comparing at least two of the area image frame data displayed in one of the display areas at different timings so as to generate an area image display parameter, and then generating an area luminance control signal according to the area image display parameter and the display mode reference; and
an area light-emitting unit control module electrically connected with the area image frame data comparison/judgment module for controlling at least the light-emitting unit corresponding to the display area to perform a luminance control mode according to the area luminance control signal.

15. The device of claim 14, wherein when the display mode reference is an animation display mode reference and the area image display parameter is larger than the display mode reference, the area image frame data comparison/judgment module determines that the display mode of the display area is an animation display mode.

16. The device of claim 15, wherein the luminance control mode is an area synchronization flash control mode for controlling a luminance intensity of the light-emitting unit corresponding to the display area to present a periodical luminance waveform, and the periodical luminance waveform and a timing of the area image frame data written into the display area are synchronized with a phase difference.

17. The device of claim 16, wherein the phase difference is ranged from 0 to 360 degrees.

18. The device of claim 15, wherein the luminance control mode is an area synchronization flash control mode for controlling luminance intensities of the light-emitting unit corresponding to the display area and another one of the light-emitting units corresponding to another one of the display areas adjacent to the display area to present a periodical luminance waveform, and the periodical luminance waveform and a timing of the area image frame data written into the display areas are synchronized with a phase difference.

19. The device of claim 18, wherein the phase difference is ranged from 0 to 360 degrees.

20. The device of claim 14, wherein the luminance control mode is a general luminance control mode.

21. The device of claim 14, wherein the two of the area image frame data are two sequentially inputted image frame data.

22. The device of claim 14, wherein the two of the area image frame data are two non-sequentially inputted image frame data.

23. The device of claim 14, wherein the display mode reference is modulated depending on a luminance.

24. The device of claim 23, wherein the luminance is a luminance of the liquid crystal display device, and the display mode reference increases as the luminance of the liquid crystal display device increases.

25. The device of claim 23, wherein the luminance is an environmental luminance, and the display mode reference increases as the environmental luminance decreases.

26. The device of claim 14, wherein the display mode reference is automatically adjusted by the liquid crystal display device or manually adjusted by a user.
